(19) United States
(12) Patent Application Publication
(10) Pub. No.: US 2008/0176065 A1
(43) Pub. Date: Jul. 24, 2008

(54) ARC FLASH RESISTANT MATERIAL

(75) Inventors: Jack Bouton Hirschmann, Dartmouth, MA (US); Thomas E. Neal, Guilford, CT (US)

Correspondence Address: HOLLAND & KNIGHT LLP, 10 ST. JAMES AVENUE, 11th Floor, BOSTON, MA, 02116-3889, US

(73) Assignee: Paramount Corporation, New Bedford, MA (US)

(21) Appl. No.: 12/055,956

(22) Filed: Mar. 26, 2008

Related U.S. Application Data
(63) Continuation-in-part of application No. 11/291,855, filed on Nov. 30, 2005, now abandoned.

(51) Int. Cl. B32B 7/02; B32B 27/40

(52) U.S. Cl. 428/332; 428/423.1

(57) ABSTRACT

An arc flash resistant material includes a para-aramid non-woven material substrate and a polyurethane film containing approximately 10-40% by weight of antimony oxide (Sb₂O₃, Sb₂O₅) and decabromodiphenyl oxide containing a high level of aromatic bromine laminated to a first surface and a second surface of the para-aramid non-woven material substrate. The arc flash resistant material may be breathable and include antistatic properties. The arc flash resistant material is light weight, exhibits an exceptionally high level of protection from an arc flash hazard, and possesses a low particulate level that is required for clean room applications.

### CROSS-REFERENCE TO RELATED APPLICATIONS

This application claims priority under 35 U.S.C. § 120 to U.S. patent application Ser. No. 11/291,855 filed on Nov. 30, 2005, entitled “FLAME-RESISTANT MATERIAL,” the entire contents of which is incorporated herein by reference.

### FIELD OF INVENTION

The present invention relates to flame-resistant materials and more specifically to arc flash resistant materials.

### BACKGROUND

All fabrics will bum but some are more flammable than others. Untreated natural fibers such as cotton and linen bum more readily than silk and wool, which are more difficult to ignite and bum with a lower flame velocity.

The weight and weave of the fabric will affect how easily the material will ignite and bum. Recommended fabrics are materials with a tight weave. Heavy, tight weave fabrics will bum more slowly than loose weave, light fabrics of the same material. The surface texture of the fabric also affects flammability. Fabrics with long, loose, fluffy pile or “brushed” nap will ignite more readily than fabrics with a hard, tight surface and in some cases will result in flames flashing across the fabric surface.

Most synthetic fabrics, such as nylon, acrylic or polyester will begin to melt prior to ignition. However, once ignited, the fabrics melt rapidly. This hot, sticky, melted substance causes localized and severe bums. When natural and synthetic fibers are blended, the hazard may increase because the combination of high rate of burning and fabric melting can readily result in serious bums.

Further, flame resistant materials generally provide limited protection from an arc flash, which is a type of electrical explosion that results in a highly concentrated arc or blast of electricity. The heat and concussive force in an arc flash can ignite and tear open clothing, even typical flame resistant materials, which cannot withstand the concussive force.

Coated or laminated flame resistant materials are also generally hot and do not provide for moisture transfer across the material. Instead, moisture from, for example, perspiration is trapped under the material, making the wearer uncomfortable. The resistance to moisture transfer may also be a problem when laundering and drying garments made from the material, particularly when moisture becomes trapped within portions of the garment made of the material.

Further still, many flame resistant materials are not suitable for use in a clean room environment. Often, these flame resistant materials consist of an uncoated fabric or fabric material coated with a flame resistant layer on only one side, enabling fibers or fibrils to be released when the material is worn or laundered. The subsequent release of fibers or fibrils in a clean room is undesirable.

### SUMMARY

In general, in one aspect, the implementation of the disclosure features an arc flash resistant material including an arc flash resistant non-woven material substrate and a flame-resistant polyurethane film laminated to a first surface and a second surface of the non-woven material substrate. The flame-resistant polyurethane film may be a polyurethane containing 10-20% antimony oxide (Sb₂O₃, Sb₂O₅) and decabromodiphenyl oxide containing a high level of aromatic bromine.

One or more of the following features may be included. The arc flash resistant non-woven material substrate may weigh approximately 1.5 ounces per square yard (oz/yd²). The arc flash resistant non-woven material may be a para-aramid non-woven material. The polyurethane may include an approximate 1:3 ratio of the antimony oxide (Sb₂O₃, Sb₂O₅) and decabromodiphenyl oxide containing the high level of aromatic bromine. The flame-resistant polyurethane film laminated to the first surface of the non-woven material substrate may also contain carbon to enable antistatic performance characteristics.

In general, in another aspect, the implementation of the disclosure features an arc flash resistant material including a para-aramid non-woven material substrate and a polyurethane film containing approximately 10-40% by weight of antimony oxide (Sb₂O₃, Sb₂O₅) and decabromodiphenyl oxide laminated to a first surface and a second surface of the para-aramid non-woven material substrate.

One or more of the following features may be included. The para-aramid non-woven material substrate may weigh approximately 1.5 ounces per square yard (oz/yd²). The polyurethane film may include an approximate 1:3 ratio of the antimony oxide (Sb₂O₃, Sb₂O₅) and decabromodiphenyl oxide. Further, the polyurethane film laminated to the first surface of the para-aramid non-woven material substrate may include carbon to enable antistatic performance characteristics. The polyurethane film may also be configured to enable the passage of moisture.

In general, in another aspect, the implementation of the disclosure features an arc flash resistant material including a para-aramid non-woven material substrate weighing approximately 1.5 ounces per square yard (oz/yd²) and a polyurethane film containing approximately 10-40% by weight of antimony oxide (Sb₂O₃, Sb₂O₅) and decabromodiphenyl oxide laminated to a first surface and a second surface of the para-aramid non-woven material substrate. The polyurethane film may be configured to enable the passage of moisture.

One or more of the following features may be included. The polyurethane film may include an approximate 1:3 ratio of the antimony oxide (Sb₂O₃, Sb₂O₅) and decabromodiphenyl oxide. The polyurethane film laminated to the first surface of the para-aramid non-woven material substrate may further include carbon to enable antistatic performance characteristics.

The polyurethane film laminated to the second surface of the substrate may be replaced with a polytetrafluoroethylene (PTFE) film laminated to the second side of the substrate. In another embodiment, the polyurethane film may be replaced with a polyvinylchloride (PVC) film including flame retardants laminated to both sides of the substrate.

The invention can be implemented to realize one or more of the following advantages. The arc resistant material is flame-resistant (FR) and light weight, while also providing an exceptionally high level of protection from an arc flash hazard.

Further, the arc resistant material, which maybe coated on both sides, possesses a low particulate level that is required for clean room applications. Also, the arc resistant material may provide better breathability by enabling the passage of moisture through the material permitting increased wearer comfort and ease of drying after laundering. Further still, the arc resistant material may provide antistatic performance.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a cross section of an exemplary arc flash resistant material.

FIG. 2 is a listing of exemplary test results.

FIG. 3 is a listing of exemplary test results.

FIG. 4 is a listing of exemplary test results.

FIG. 5 is a listing of exemplary test results.

Like reference numbers and designations in the various drawings indicate like elements.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

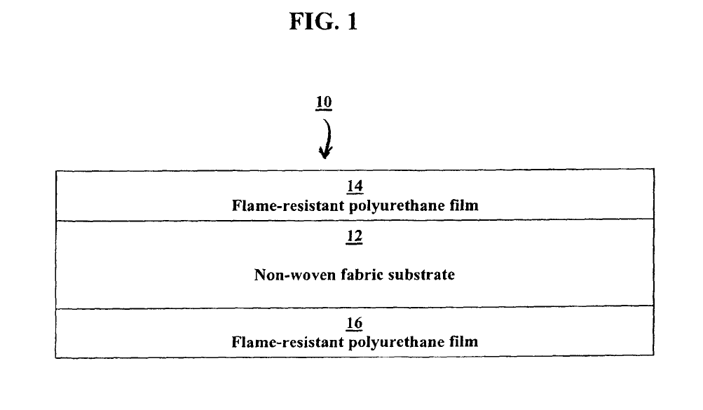

As shown in FIG. 1, a cross section of an exemplary arc flash resistant material 10 includes a non-woven material substrate 12 having polyurethane films 14, 16 containing flame retardants (FR) laminated to both sides of the material substrate 12. One of the FR polyurethane films, film 14, for example, may include carbon to enable antistatic performance. The carbon may be in a powder form and added to the polyurethane prior to forming the polyurethane into a film. Laminating both sides of the material substrate 12 with polyurethane films 14, 16 may prevent the generation of fiber particles that could contaminate a clean room environment.

In a particular example, the non-woven material substrate 12 may be a para-aramid, non-woven material having a weight of approximately 1.5 ounce/square yard (oz/yd²). Para-aramid, non-woven materials are available as KEVLAR® from E. I. DuPont, as TECHNORA® from Teijin, and as TWARON® from Teijin Twaron.

The polyurethane films 14, 16 may be a breathable polyurethane film that enables the passage of moisture through the arc flash resistant material 10. While the breathability may be provided by any known method, preferably the breathability is provided by hydrophilic action to minimize the porosity, or openings, in the polyurethane film. Such polyurethane films are available from Dartex Coatings Limited of Long Eaton, Nottingham, United Kingdom. The two breathable polyurethane films 14, 16 may be configured to enable the transmission of sufficient moisture to provide a garment made of the arc flash resistant material 10 that is more comfortable than a garment made of a material that does not enable transmission of moisture. Further, the two breathable polyurethane films 14, 16 may enable conventional machine drying of garments made of the arc flash resistant material 10 after the garment is laundered.

The polyurethane films 14, 16 including the flame retardants provide flame-resistance, while the para-aramid, non-woven material substrate 12 provides mechanical strength for added break open resistance during, for example, a high temperature arc flash exposure. The polyurethane films 14, 16 on both sides of the material substrate 12 enable a lightweight but highly effective heat barrier during an arc flash exposure, as well as encapsulate the non-woven material substrate 12 to prevent loose fibers from breaking away from the arc flash resistant material 10.

The polyurethane films 14, 16 may include antimony oxide (Sb₂O₃, Sb₂O₅) and decabromodiphenyl oxide containing a high level of aromatic bromine as the flame retardants. Decabromodiphenyl oxide containing a high level of aromatic bromine is available as Saytex® 102E from Albemarle Corporation, for example. In one particular example, one part of antimony oxide and three parts of decabromodiphenyl oxide containing a high level of aromatic bromine may be used for a total loading of 10% to 20% in the polyurethane. In another example, one part of antimony oxide and three parts of decabromodiphenyl oxide containing a high level of aromatic bromine may be used for a total loading of 10% to 40% in the polyurethane.

In another particular example, the arc flash resistant material 10 may include a non-woven meta-aramid/para-aramid blend substrate with a polyurethane film laminated to a first side of the substrate and a polytetrafluoroethylene (PTFE) film laminated to a second side of the substrate. In this example, only the polyurethane film includes flame retardants.

In another example, the arc flash resistant material 10 can include a non-woven meta-aramid/para-aramid substrate with a FR polyvinylchloride (PVC) film laminated to both sides of the substrate.

In still another example, the arc flash resistant material 10 can include a woven meta-aramid/FR rayon blend substrate with polyurethane film laminated on a first side of the substrate and a PTFE film laminated to a second side of the substrate. In this example, only the polyurethane film includes flame retardants.

The arc flash resistant material 10 has many applications. For example, arc flash resistant material 10 can be used to design clothing for electricians working in clean rooms and other workers who are required to work in clean environments in which there are fire hazards or arc flash hazards. In general, a clean room is a manufacturing environment that has a very low level of environmental pollutants such as dust, airborne microbes, aerosol particles and chemical vapors. More specifically, a clean room has a controlled level of contamination that is specified by the number of particles per cubic meter and by particle size.

Arc flash resistant material 10 can effectively replace existing flame resistant clean room materials, such as those made of NOMEX® meta-aramid filament yarns from E. I. DuPont. The NOMEX® meta-aramid filament material is approximately five times the price of a para-aramid arc flash resistant material 10. In addition, NOMEX® meta-aramid filament material may be in short supply due to its use in military clothing.

The following are brief descriptions of selected critical performance specifications impacting industrial flame-resistant clothing. Each standard specification uses test methods to verify performance, and defines the minimum or maximum test performance required on each test to comply with the standard.

The ASTM F1506 Standard Performance Specification for Textile Materials for Wearing Apparel for Use by Electrical Workers Exposed to Momentary Electric Arc and Related Thermal Hazards specification provides performance requirements for clothing worn by electric utility workers and other personnel working around energized parts. In addition to non-thermal requirements, the standard requires the material to be flame-resistant; that is, to not ignite and continue to burn after exposure to an ignition source. Flame resistance is measured using ASTM D6413 Vertical Flame test (max. 2 sec afterflame and 6 in. char length). The standard also includes a requirement of reporting an Arc Rating. The Arc Rating is either the Arc Thermal Performance Value (ATPV) or Arc Breakopen Value (EBT) as measured by ASTM F1959 Arc Thermal Performance Test.

The NFPA 2112 Standard for Flame-Resistant Garments for Protection of Industrial Personnel against Flash Fire is the first US standard that specifically addresses the need for industrial flame-resistant uniforms. This standard requires FR materials to pass a comprehensive battery of thermal tests, including

Vertical flammability (maximum 2 sec after flame and 4 in. char length)

Thermal Protective Performance (TPP) test (minimum TPP of 6 cal/cm² spaced and 3 cal/cm² in contact)

Thermal Stability Test (material must not melt or drip, separate or ignite after 5 minutes in a 500° F. oven)

Thermal Shrinkage Test (less than 10% after 5 min in a 500° F. oven)

ASTM F1930 Thermal Mannequin Test (maximum 50% body burn after 3 sec flash fire)

NFPA 70E Standard for Electrical Safety in the Workplace, 2004 Edition, addresses electrical hazard threats that are present in the workplace. NFPA 70E requires that the employer shall document the incident energy exposure of the worker when it has been determined that the worker will be performing tasks within the flash protection boundary.

NFPA 70E bases incident energy exposure levels on the working distance of the employee's face and chest areas from a prospective arc source for the specific task to be performed. Flame Resistant, Arc Rated Clothing and Personal Protective Equipment shall be used by the employee, and an adequate level of protection based upon the incident energy exposure associated with the specific task shall be worn.

In comparative testing, a NOMEX® filament material weighing 5 oz/yd², or 1.47 times higher than arc flash resistant material 10 at 3.4 oz/yd², was compared with an example of an example of para-aramid arc flash resistant material 10. NOMEX® arc rating is 6.3 or 57% of the arc rating of 11 for arc flash resistant material 10. NOMEX® filament material meets NFPA 70E Hazard Risk Category 1 (HRC1, 4 cal/cm²) while arc flash resistant material 10 meets Hazard Risk Category 2 (HRC2, 8 cal/cm²).

Most clean room workers do not require FR clean room garments. The standard clean room garment is constructed from polyester filament yarns that are woven very tightly to prevent particles from moving through the material. Polyester filament, when exposed to an arc flash or flash fire, melts and ignites, thus causing serious burn injuries to the wearer.

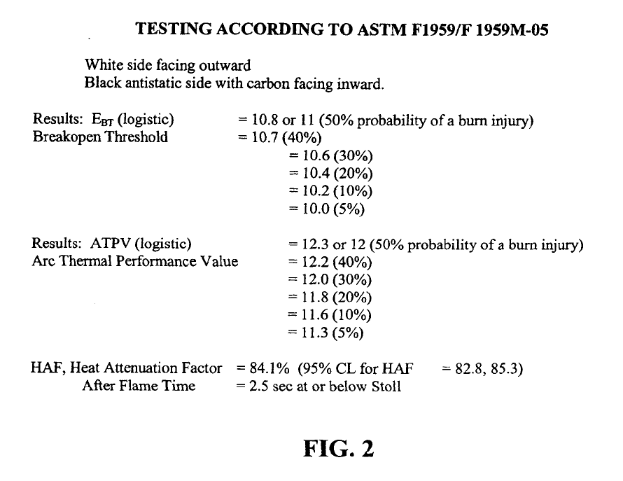

In FIG. 2, arc testing results for arc flash resistant material 10 according to ASTM F1959 are illustrated.

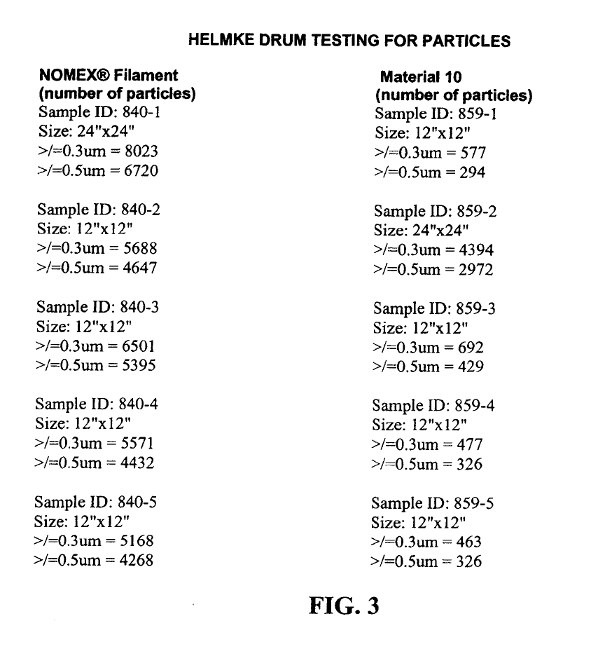

In FIG. 3, Helmke drum test results for arc flash resistant material 10 and NOMEX® filament material are illustrated. In the Helmke drum test, a garment or consumable is tumbled in a stainless steel drum while particle counts are taken in the air above it. An airborne particle counter is used to determine the number of particles with a size greater than 0.3 microns per cubic foot of air (number of particles>0.3μ per ft³). This test was initially developed for barrier garments, such as those made from filament polyesters, laminates or coated materials, but has been adapted to all types of clean room supplies. This test measures easily releasable particles on the item's surface.

The arc flash resistant material 10, when tested according to the vertical flame test specified in ASTM D6413, exhibits less than a 6 inch char length and less than 2 seconds of after flame, which meets the requirements specified in ASTM F1506-2a.

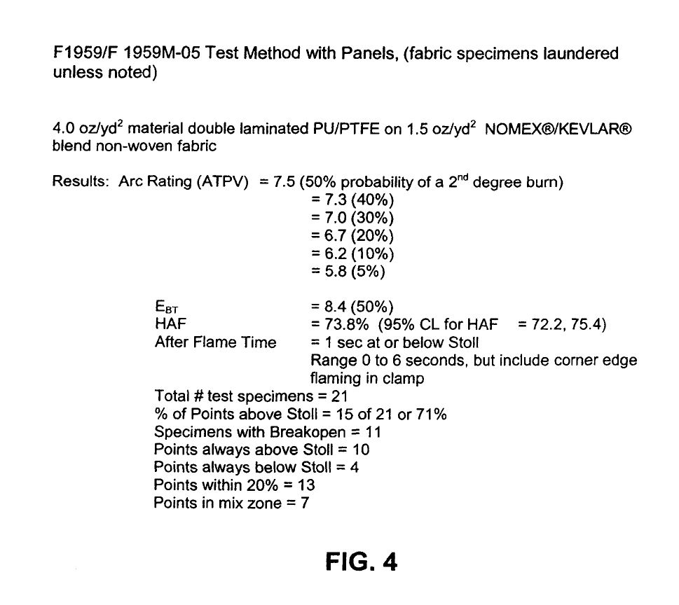

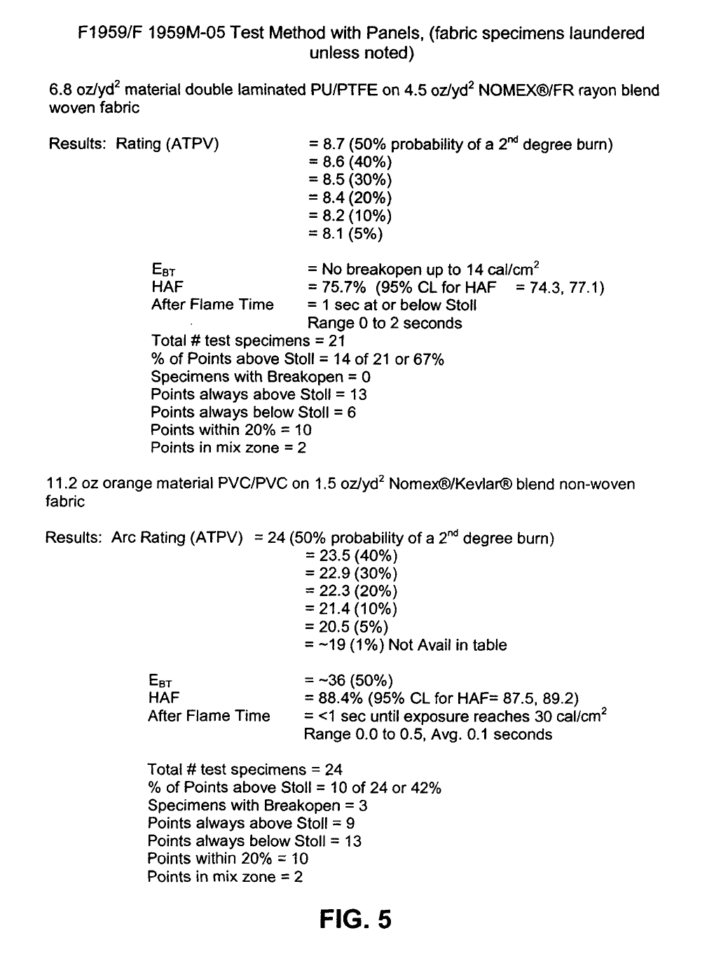

As shown in FIG. 4 and FIG. 5, additional illustrative ASTM F1959 test results are listed for materials containing various fiber blends in woven and non-woven fabric material.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. An arc flash resistant material comprising:
an arc flash resistant non-woven material substrate; and
a flame-resistant polyurethane film laminated to a first surface and a second surface of the non-woven material substrate, wherein the flame-resistant polyurethane film comprises a polyurethane containing 10-20% antimony oxide (Sb₂O₃, Sb₂O₅) and decabromodiphenyl oxide containing a high level of aromatic bromine.

2. The arc flash resistant material of claim 1 wherein the arc flash resistant non-woven material weighs approximately 1.5 ounces per square yard (oz/yd²).

3. The arc flash resistant material of claim 1 wherein the arc flash resistant non-woven material is a para-aramid non-woven material.

4. The arc flash resistant material of claim 1 wherein the polyurethane comprises an approximate 1:3 ratio of the antimony oxide (Sb₂O₃, Sb₂O₅) and decabromodiphenyl oxide containing the high level of aromatic bromine.

5. The arc flash resistant material of claim 1 wherein the flame-resistant polyurethane film laminated to the first surface of the non-woven material substrate contains carbon to enable antistatic performance characteristics.

6. An arc flash resistant material comprising:
a para-aramid non-woven material substrate; and
a polyurethane film containing approximately 10-40% by weight of antimony oxide (Sb₂O₃, Sb₂O₅) and decabromodiphenyl oxide laminated to a first surface and a second surface of the para-aramid non-woven material substrate.

7. The arc flash resistant material of claim 6 wherein the para-aramid non-woven material substrate weighs approximately 1.5 ounces per square yard (oz/yd²).

8. The arc flash resistant material of claim 6 wherein the polyurethane film comprises an approximate 1:3 ratio of the antimony oxide (Sb₂O₃, Sb₂O₅) and decabromodiphenyl oxide.

9. The arc flash resistant material of claim 6 wherein the polyurethane film laminated to the first surface of the para-aramid non-woven material substrate comprises carbon to enable antistatic performance characteristics.

10. The arc flash resistant material of claim 6 wherein the polyurethane film is configured to enable the passage of moisture.

11. An arc flash resistant material comprising:
a para-aramid non-woven material substrate weighing approximately 1.5 ounces per square yard (oz/yd²); and
a polyurethane film containing approximately 10-40% by weight of antimony oxide (Sb₂O₃, Sb₂O₅) and decabromodiphenyl oxide laminated to a first surface and a second surface of the para-aramid non-woven material substrate, wherein the polyurethane film is configured to enable the passage of moisture.

12. The arc flash resistant material of claim 11 wherein the polyurethane film comprises an approximate 1:3 ratio of the antimony oxide (Sb₂O₃, Sb₂O₅) and decabromodiphenyl oxide.

13. The arc flash resistant material of claim 11 wherein the polyurethane film laminated to the first surface of the para-aramid non-woven material substrate comprises carbon to enable antistatic performance characteristics.

14. The arc flash resistant material of claim 11 wherein the polyurethane film laminated to the second surface of the substrate is replaced with a polytetrafluoroethylene (PTFE) film laminated to the second side of the substrate.

15. The arc flash resistant material of claim 11 wherein the polyurethane film is replaced with a polyvinylchloride (PVC) film including flame retardants laminated to both sides of the substrate.
